(19) United States
(12) Patent Application Publication
(10) Pub. No.: US 2012/0292822 A1
(43) Pub. Date: Nov. 22, 2012

(54) MOLD FOR MORTAR GROUT PRISMS

(76) Inventors: Kenneth M. Flynn, Tampa, FL (US); Marquise D. Williams, Tampa, FL (US)

(21) Appl. No.: 13/109,398

(22) Filed: May 17, 2011

(51) Int. Cl. B28B 7/26; B28B 7/24

(52) U.S. Cl. 264/297.9; 249/121

(57) ABSTRACT

A mold for casting precise 3-inch by 3-inch by 6-inch mortar grout prisms with minimal set-up time may be reusable for each test and may allow testing of, for example, multiple trucks of mortar grout, if required. The mold may include a U-shaped main body, side walls, a lid, and a divider. The main body and the side walls may form an open container into which the divider fits and divides the open container into four equal compartments. The mold may be made of, for example, hard plastic, which can be reused multiple times.

### BACKGROUND OF THE INVENTION

The present invention relates to methods and apparatus for molding mortar grout prisms and, more particularly, to methods and apparatus for molding precise 3-inch by 3-inch by 6-inch mortar grout prisms, four at a time.

Grout used in masonry is a fluid mixture of cementitious materials and aggregate with high water content for ease of placement. During construction, grout is placed within or between absorptive masonry units. ASTM 1019-09, for example, provides a mortar grout prism testing method.

There are two conventional methods for casting mortar grout prisms. One method, called the pinwheel method, uses sixteen blocks, placed in a pinwheel pattern, to provide four 3-inch by 3-inch channels for pouring mortar grout. This method requires the user to carry and manually set up the blocks, which can take about an hour of time. This method requires a large, flat area for setting up the blocks. Another method uses a cardboard box having a divider formed therein, to form four mortar grout prisms. This method may result in variable sized mortar grout prisms due to the flexibility of wet cardboard. Both of the above methods provides a one-time use and a new pinwheel or a new box must be used for the next mortar grout prism test. Also, damage may occur when retrieving test specimens from the current testing apparatus.

As can be seen, there is a need for an apparatus and method for casting mortar grout prisms consistently and repeatedly with a single, reusable mold.

### SUMMARY OF THE INVENTION

In one aspect of the present invention, a mortar grout prism mold comprises a main body having a bottom member and side members extending orthogonally from opposite ends of the bottom member; first and second side walls removably attachable to the main body to form an open container; a central partition fitting inside the open container to divide the open container into four chambers; and a lid fitting over the open container.

In another aspect of the present invention, a method for molding mortar grout prisms comprises pouring grout mix to partially fill a mortar grout prism mold, the grout prism mold including a main body having a bottom member and side members extending orthogonally from opposite ends of the bottom member, first and second side walls removably attachable to the main body to form an open container, and a central partition fitting inside the open container to divide the open container into four chambers; inserting and removing a rod into each chamber a plurality of times; filling the mortar grout prism mold with the grout mix; inserting and removing the rod into each chamber a plurality of times; screed excess grout mix off the top of the open container; and securing a lid over the open container.

These and other features, aspects and advantages of the present invention will become better understood with reference to the following drawings, description and claims.

### BRIEF DESCRIPTION OF THE DRAWINGS

FIG. 1 is a perspective view of a mortar grout prism mold according to an exemplary embodiment of the present invention;

FIG. 2 is a partially exploded perspective view of the mortar grout prism mold of FIG. 1; and

FIG. 3 is a fully exploded perspective view of the mortar grout prism mold of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a mold for casting precise 3-inch by 3-inch by 6-inch mortar grout prisms with minimal set-up time. The mold may be reusable for each test and may allow testing of, for example, every truck of mortar grout, if required. The mold may include a U-shaped main body, side walls, a lid, and a divider. The main body and the side walls may form an open container into which the divider fits and divides the open container into four equal compartments. The mold may be made of, for example, hard plastic, which can be reused multiple times.

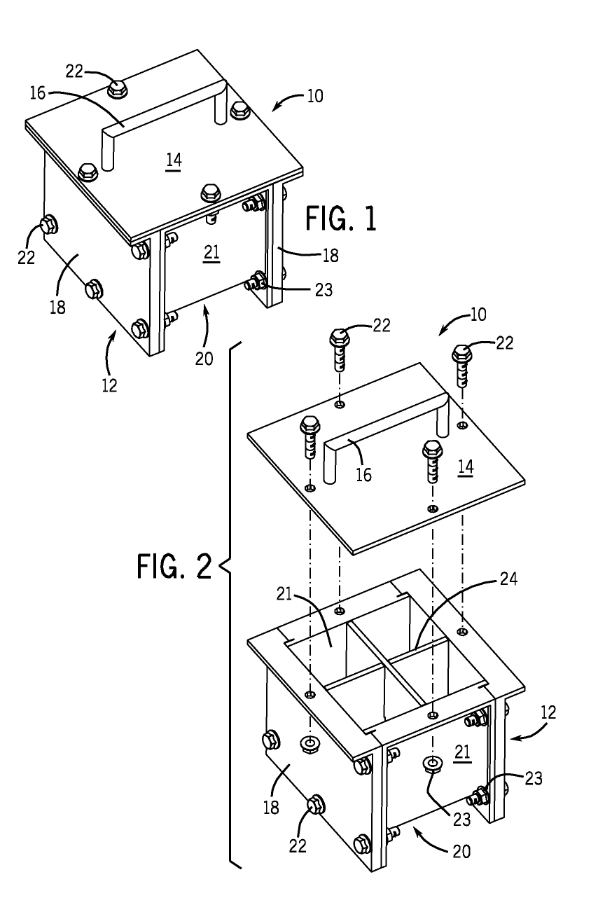

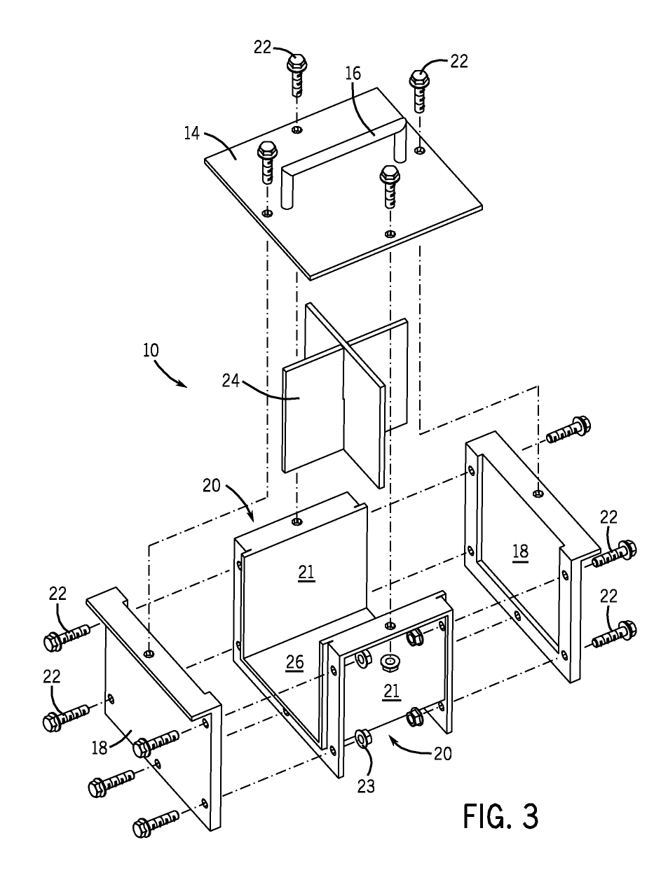

Referring to FIGS. 1 through 3, a mortar grout prism mold 10 (also referred to as mold 10) may include an open container 12 and a lid 14. The open container 12 may be formed from a main body 20 and first and second side walls 18. The main body 20 may be formed in a rectangular U-shape from a bottom member 26 and side members 21. The side members 21 may be attached to and extend orthogonally from the bottom member 26. The side walls 18 may attach to ends of the main body 20 to form the open container 12. Bolts 22 and nuts 23, for example, may be used to attach the side walls 18 to the main body 20. The depth of the open container 12 may be about 6-inches. The inside dimensions of the open container 12 may be about 6¼ inches by 6¼ inches. The side walls 18 may be identical and may attach to either side of the main body 20.

A central partition 24 may fit inside the open container 12. The central partition 24 may divide the open container 12 into 4 equal portions. These portions may have a cross-sectional dimension of about 3-inches by about 3-inches. The central partition 24 may be about ¼ inch thick, thereby providing the 3-inch by 3-inch chambers in the mold 10.

The lid 14 may fit over the open container 12 to form the mold 10. Bolts 22 and nuts 23, for example, may be used to secure the lid 14 on the open container 12. In some embodiments, the bolts 22 may secure the lid 14 to each side member 21 of the main body 20 as well as to each side wall 18. A handle 16 may be attached to the lid 14. The lid 14 may be, for example, about 8¾ inches square, with a ¼ inch thickness. The lid 14 may be designed to fit on the open container 12 in any direction with all bolt holes still lining up.

A temperature gauge (not shown), such as a dial or a digital temperature gauge may be added to provide a temperature readout of the mold 10.

To use the mold 10, a user may screw the side walls 18 to the main body 20. The central partition 24 may then be inserted in the open container 12. A scoop of mix (mortar grout mix) may be placed in all four compartments of the open container 12. This scoop of mix may not fill the compartments. A ¼ inch rod may be inserted about 25 times into each compartment. Another scoop of mix may then be placed in all four compartments and the ¼ inch rod may be inserted into each compartment, again about 25 times in each. Excess mix may be leveled off with a screed and the lid may be attached to form the mold. The test specimens may be retrieved by removing the bolts and separating the lid 14 and the side walls 18 from the main body 20. The mold 10 may be reused as needed.

It should be understood, of course, that the foregoing relates to exemplary embodiments of the invention and that modifications may be made without departing from the spirit and scope of the invention as set forth in the following claims.

What is claimed is:

1. A mortar grout prism mold comprising:
a main body having a bottom member and side members extending orthogonally from opposite ends of the bottom member;
first and second side walls removably attachable to the main body to form an open container;
a central partition fitting inside the open container configured to divide the open container into four chambers; and
a lid fitting over the open container.

2. The mortar grout prism mold of claim 1, further comprising a handle attached to the lid.

3. The mortar grout prism mold of claim 1, wherein the open container has a length of 6¼ inches, a width of 6¼ inches and a depth of 6 inches.

4. The mortar grout prism mold of claim 3, wherein the central partition has a thickness of ¼ inch.

5. The mortar grout prism mold of claim 4, wherein each of the four chambers has a dimension of 3 inches by 3 inches by 6 inches.

6. The mortar grout prism mold of claim 1, wherein the first and second side walls attach to the main body with bolts and nuts.

7. A method for molding mortar grout prisms, comprising:
pouring grout mix to partially fill a mortar grout prism mold, the grout prism mold including a main body having a bottom member and side members extending orthogonally from opposite ends of the bottom member, first and second side walls removably attachable to the main body to form an open container, and a central partition fitting inside the open container to divide the open container into four chambers;
inserting and removing a rod into each chamber a plurality of times;
filling the mortar grout prism mold with the grout mix;
inserting and removing the rod into each chamber a plurality of times;
screed excess grout mix off the top of the open container; and
securing a lid over the open container.

8. The method of claim 7, further comprising assembling the mortar grout prism mold by removably bolting the side walls to the main body.

9. The method of claim 7, further comprising removing the lid and side walls from the main body to remove specimens from the mold, allowing a user to reuse the mold.

10. The method of claim 7, wherein the plurality of times is about 25 times.
